(19) United States
(12) Patent Application Publication
(10) Pub. No.: US 2014/0119910 A1
(43) Pub. Date: May 1, 2014

(54) TURBINE EXHAUST HOOD AND RELATED METHOD

(71) Applicant: GENERAL ELECTRIC COMPANY, Schenectady, NY (US)

(72) Inventors: Kenneth Michael Koza, Ballston Lake, NY (US); Kumar Navjot, Jamshedpur (IN); Daniel Ross Predmore, Ballston Lake, NY (US)

(73) Assignee: GENERAL ELECTRIC COMPANY, Schenectady, NY (US)

(21) Appl. No.: 13/662,997

(22) Filed: Oct. 29, 2012

(51) Int. Cl. F01D 25/24; B23P 11/00

(52) U.S. Cl. 415/214.1; 29/889.22; 29/889.1

(57) ABSTRACT

A turbine exhaust hood and related method of installation is disclosed. In one embodiment, the turbine exhaust hood includes: a housing having an end wall, the end wall including a first portion of a releasable coupling, and a first radially inner steam guide structure disposed within the housing, the first radially inner steam guide structure including a second portion of the releasable coupling, integral with a first end of the first radially inner steam guide structure. The first portion and the second portion of the releasable coupling releasably couple the first radially inner steam guide structure to the end wall.

### FIELD OF THE INVENTION

The subject matter disclosed herein relates to power systems. Specifically, the subject matter disclosed herein relates to an exhaust hood for a turbine system and methods of installing the exhaust hood.

### BACKGROUND OF THE INVENTION

Low-pressure (LP) steam turbines utilize exhaust hoods to move exhaust steam from the last stage buckets of the turbine to condensers. Within the LP steam turbine, the steam discharges from the last set of the last stage buckets to an exhaust flow passage formed within the exhaust hood. In conventional exhaust hoods, the exhaust flow passage is formed by the outer surface of an exhaust cone, which surrounds the rotor of the turbine, an end wall of the exhaust hood, and a flow guide attached to an inner casing of the LP steam turbine system. In conventional systems, the exhaust hood, cone and flow guide are custom made to create a unique exhaust flow passage for each LP steam turbine. The custom components are made to optimize performance in the LP steam turbine. The custom shape and configuration of the exhaust cone and flow guide are, in-part, dependent on the size and location of the last stage buckets, the type of condenser used (e.g., water cooled, air cooled, etc.) and the desired aerodynamic performance to maintain within the exhaust hood. The exhaust cone is fixed to the exhaust hood, and the flow guide is fixed to the inner casing of the LP steam turbine.

Conventionally, once the LP steam turbine system is designed, the respective exhaust flow passage is not easily modified. The re-design of the exhaust flow passage is time consuming and resource-intensive. Typically, in-field modifications are expensive and involve major alterations (e.g., torch cutting, grinding, welding, etc.) to the exhaust hood and its components. More particularly, where an LP steam turbine system may substitute the type of condenser it utilizes or replace the last stage buckets with a dimensionally different set of last stage buckets, the exhaust hood must be modified to create a new exhaust flow passage. In some instances, the exhaust hood must be replaced as a whole when modifications will be too costly or diminish the efficiency of the LP steam turbine system. While operation costs may be reduced by utilizing interchangeable components of the LP steam turbine systems to meet changing power demands, optimum operation often requires new or extensively modified exhaust hoods to maintain efficiency within the LP steam turbine system.

Moreover, in conventional LP turbine systems, each exhaust hood is designed for a specific LP turbine system having last stage buckets with distinct dimensions. In conventional LP turbine systems, a new exhaust hood must be manufactured with exact dimensions to fit the specific LP turbine system. That is, a single exhaust hood cannot be configured to fit a plurality of LP turbine systems, but rather, each exhaust hood is custom to the LP turbine system that utilizes the hood. Similar to the exhaust cone and flow guide, this customization requirement of the exhaust hood increases cost of operation and maintenance for conventional LP turbine systems.

### BRIEF DESCRIPTION OF THE INVENTION

A turbine exhaust hood and related method of installation is disclosed. In one embodiment, the turbine exhaust hood includes: a housing having an end wall, the end wall including a first portion of a releasable coupling; and a first radially inner steam guide structure disposed within the housing, the first radially inner steam guide structure including a second portion of the releasable coupling, integral with a first end of the first radially inner steam guide structure, wherein the first portion and the second portion of the releasable coupling releasably couple the first radially inner steam guide structure to the end wall.

A first aspect of the invention includes a turbine exhaust hood having: a housing having an end wall, the end wall including a first portion of a releasable coupling; and a first radially inner steam guide structure disposed within the housing, the first radially inner steam guide structure including a second portion of the releasable coupling, integral with a first end of the first radially inner steam guide structure, wherein the first portion and the second portion of the releasable coupling releasably couple the first radially inner steam guide structure to the end wall.

A second aspect of the invention includes a steam guide structure having: a body having: a first end including a first portion of a releasable coupling, the first end configured to be releasably coupled to a turbine exhaust hood via the first portion of the releasable coupling; and, a second end located substantially proximate the first end and positioned within the turbine exhaust hood.

A third aspect of the invention includes a method. The method includes: providing a first steam guide structure; releasably coupling the first steam guide structure to a turbine exhaust hood; and installing the turbine exhaust hood onto a first turbine system, the first turbine system including a first set of last stage buckets having a first length.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a vertical cross-sectional view of an exhaust hood including a first radially inner steam guide structure, according to embodiments of the invention.

FIG. 2 shows a vertical cross-sectional view of an exhaust hood including a first radially inner steam guide structure, according to an alternative embodiment of the invention.

FIG. 3 shows a partial cross-section side view of an exhaust hood including a first radially inner steam guide structure, according to embodiments of the invention.

FIG. 4 shows a vertical cross-sectional side view of an exhaust hood, including a first radially inner steam guide structure and a portion of a first turbine system, according to embodiments of the invention.

FIG. 5 shows a vertical cross-sectional sides view of an exhaust hood, including a second radially inner steam guide structure and a portion of a second turbine system, according to embodiments of the invention.

FIG. 6 shows a vertical cross-sectional comparative view of the exhaust hood, including the first radially inner steam guide structure and associated portion of the first turbine system and the second radially inner steam guide structure and associated portion of the second turbine system, according to embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As described herein, aspects of the invention relate to a turbine exhaust hood. Specifically, as described herein, aspects of the invention relate to a low-pressure turbine exhaust hood having interchangeable radially inner and outer steam guide structures that correspond to specific last stage buckets used in a steam turbine.

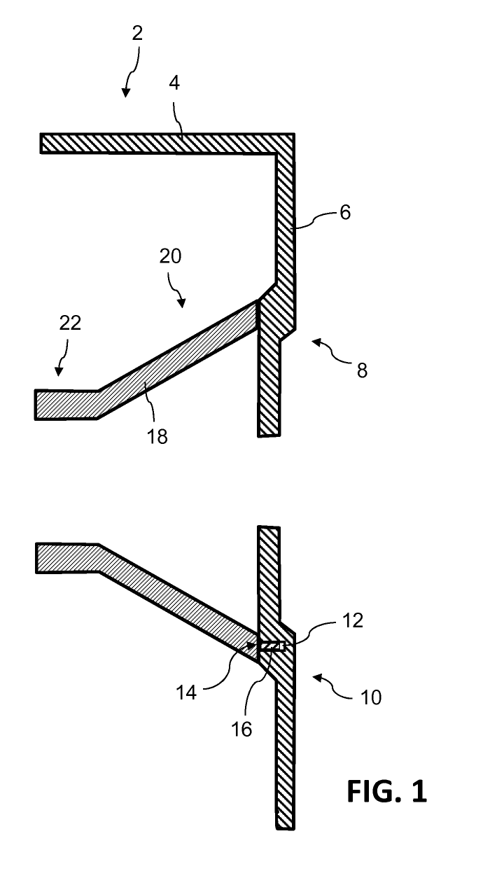

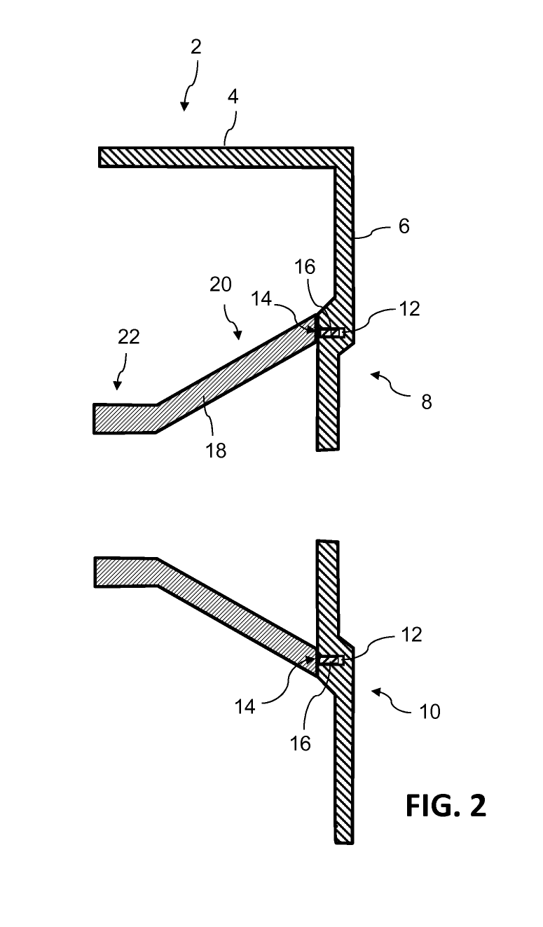

Turning to FIG. 1, a vertical cross-sectional view of a turbine exhaust hood including a first radially inner steam guide structure, according to embodiments of the invention is provided. Exhaust hood 2 may include a housing 4 having an end wall 6. Housing 4 may also include an upper portion 8 of housing 4 and a lower portion 10 of housing 4. In an embodiment, upper portion 8 and lower portion 10 may be coupled to each other via a horizontal coupling joint (not shown). In an alternative embodiment, housing 4 may be produced as a single component or in a plurality of portions coupled together. End wall 6 of exhaust hood 2 may also include a first portion 12 of a releasable coupling 14. In an embodiment, as best shown in FIG. 1, first portion 12 of releasable coupling 14 may be integral with lower portion 10 of housing 4. As shown in FIG. 1, first portion 12 of releasable coupling 14 may be configured to receive a second portion 16 of releasable coupling 14 integral with a first radially inner steam guide structure 18. More specifically, as shown in FIG. 1, first portion 12 of releasable coupling 14 may be configured as an opening, and second portion 16 of releasable coupling 14 may be configured as a bolt. In the embodiment, first portion 12 (e.g., opening) receives second portion 16 (e.g., bolt), such that first radially inner steam guide structure 18 may be releasably coupled to end wall 6 of housing 4. In an alternative embodiment, not shown, releasable coupling 14 may configured as any one of: a screw-nut coupling, snap-fit connection, or any other now known, or later developed means for releasably coupling first radially inner steam guide structure 18 to end wall 6 of housing 4. In another embodiment, not shown, second portion 16 may be configured to receive first portion 12 of releasable coupling 14. In a further embodiment, as shown in FIG. 2, end wall 6 of housing 4 and first radially inner steam guide structure 18 may include a plurality of releasable couplings 14. In the further embodiment, as shown in FIG. 2, upper portion 8 and lower portion 10 of end wall 6 may each include first portions 12 of releasable couplings 14. Additionally, first radially inner steam guide structure 18 may include a plurality of second portions 16 of releasable couplings 14, in relation to first portions 12 included on upper portion 8 and lower portion 10 of end wall 6.

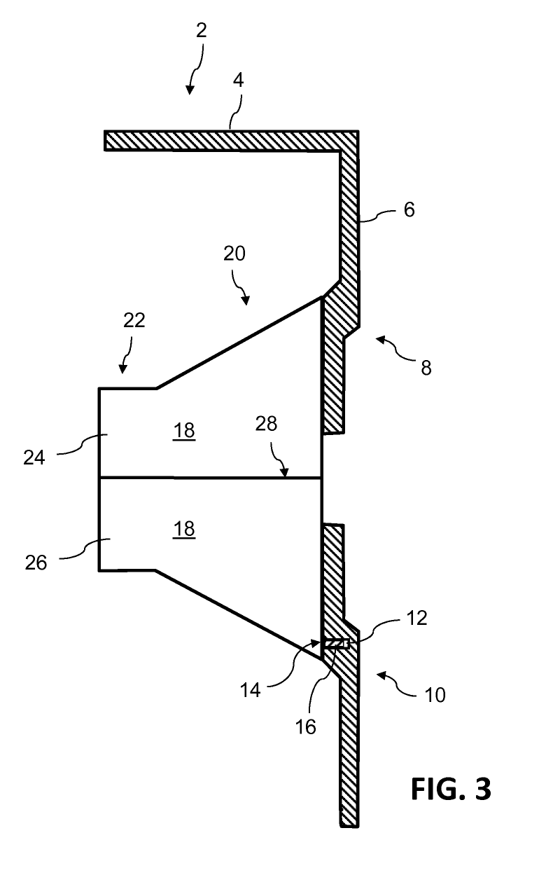

First radially inner steam guide structure 18 may be disposed within housing 4, shown best in FIGS. 1 and 3, and may include a first end 20 and a second end 22. As shown in FIGS. 1 and 3, second portion 16 of releasable coupling 14 may be integral with first end 20. First end 20 may also be releasably coupled to end wall 6 via releasable coupling 14, such that an edge of first end 20 may substantially abut end wall 6. As shown in FIGS. 1 and 3, second end 22 may be integral with first end 20 and may be positioned substantially approximate first end 20 and end wall 6, respectively. In the embodiment, as shown in FIGS. 1 and 3, first end 20 may include a substantially frusto-conical shape, and second end 22 may include a substantially cylindrical shape. In an alternative embodiment, not shown, first radially inner steam guide structure 18 may include a substantially curved frusto-conical shape.

Turning to FIG. 3, a partial cross-sectional view of an exhaust hood including a first radially inner steam guide structure, according to embodiments of the invention is provided. As shown in FIG. 3, first radially inner steam guide structure 18 may include an upper half 24 and a lower half 26. In the embodiment, as shown in FIG. 3, upper half 24 and lower half 26 may be configured to be releasably coupled to one another via a horizontal coupling joint 28. More specifically, upper half 24 and lower half 26 may be configured to coupled by any now known or later developed releasable coupling means, e.g., bolt-nut, snap-fit, screws, etc. In another embodiment, not shown, upper half 24 and lower half 26 may be permanently coupled to one another by any now know or later developed substantially permanent coupling means, e.g., welding, initial casting of first radially inner steam guide structure, etc.

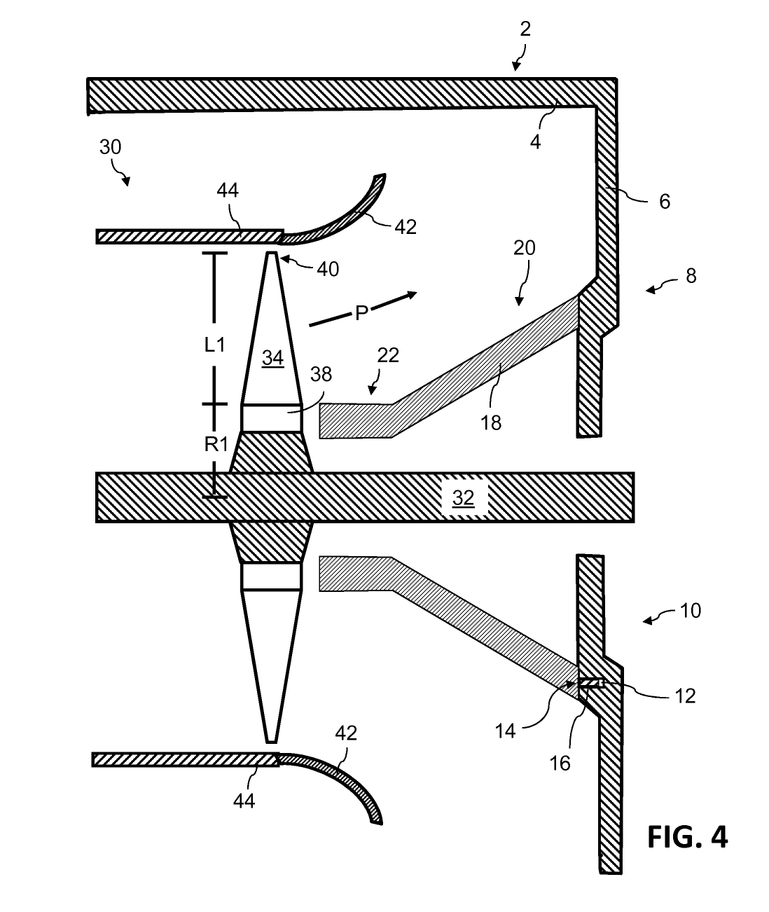

Turning to FIG. 4, a vertical cross-sectional view of an exhaust hood 2, including a portion of a first turbine system 30, according to embodiments of the invention is provided. First turbine system 30 may be disposed substantially within exhaust hood 2, and more specifically, exhaust hood 2 may form an outer shell for first turbine system 30 and the components included within first turbine system 30. In the embodiment, first turbine system 30 may be any conventional low-pressure steam turbine. As such, basic functionality of majority of the components may be omitted for clarity. In an embodiment, as best shown in FIG. 4, first turbine system 30 may include a first rotor 32 having at least a portion disposed within exhaust hood 2. As best shown in FIG. 4, the portion of first rotor 32 disposed within exhaust hood 2 may be substantially concentric with first radially inner steam guide structure 18. More specifically, first rotor 32 may be substantially concentric with a first end 20 and a second end 22 of first radially inner steam guide structure 18, such that first rotor 32 may be in approximate horizontal alignment with horizontal coupling joint 28 (FIG. 3) of first radially inner steam guide structure 18.

In an embodiment, as shown in FIG. 4, first turbine system 30 may also include a first set of last stage buckets (LSB) 34, a plurality of first sets of middle stage buckets (not shown), and a first set of first stage buckets (not shown). First set of LSB 34 may be releasably coupled to first rotor 32 via a base 38 of first set of LSB 34. More specifically, first set of LSB 34 may be concentrically and releasably coupled to first rotor 32. As best shown in FIG. 4, first set of LSB 34 may include a first length (L1) positioned at first radial position (R1). First length (L1) of first set of LSB 34 may be measured from the top of base 38 to a tip 40 of each of the first set of LSB 34. First radial position (R1) may include the radial distance of first rotor 32 and the height of base 38 of first set of LSB 34.

First turbine system 30 may also include a first outer steam guide structure positioned radially outward of first inner steam guide structure 18. This first outer steam guide structure may be referred to as a first radially outer steam guide structure 42. First radially outer steam guide structure 42 may be coupled to an inner casing assembly 44 of first turbine system 30. More specifically, first radially outer steam guide structure 42 may be coupled to an end of inner casing assembly 44, such that first radially outer steam guide structure 42 may be substantially disposed within housing 4 of exhaust hood 2. In an alternative embodiment, radially outer steam guide structure 42 may be coupled to a diaphragm, integral with inner casing assembly 44. In a further alternative embodiment, radially outer steam guide structure 42 may be coupled a carrier integral with inner casing assembly 44. In some embodiments, the space within exhaust hood 2 between first radially outer steam guide structure 42 and first radially inner steam guide structure 18 may form a steam path (P) for moving steam from turbine system 30 to the condenser (not shown) positioned at the exit of exhaust hood 2. Specifically, as best shown in FIG. 4, steam path (P) may be formed by positioning second end 22 of first radially inner steam guide structure 18 substantially adjacent base 38 of first set of LSB 34, and positioning first radially outer steam guide structure 42 substantially adjacent tip 40 of first set of LSB 34. Furthermore in the embodiment, as shown in FIG. 4, inner casing assembly 44 of first turbine system 30 may house first set of LSB 34 and middle stage buckets, respectively.

In an embodiment, as shown in FIG. 4, first radially inner steam guide structure 18 and first radially outer steam guide structure 42 may correspond specifically to first set of LSB 34. More specifically, exhaust hood 2 may have a custom-built first radially inner steam guide structure 18 and a custom-built first radially outer steam guide structure 42 releasably coupled to housing 4 based upon the predetermined size of first set of LSB 34 that may be used in first turbine system 30. As discussed above, the custom-built first radially inner steam guide structure 18 and custom-built first radially outer steam guide structure 42 may provide an optimum steam path (P) for turbine system 30 having first set of LSB 34 during operation of first turbine system 30.

It is understood that features of any steam guide structure described herein may be interchangeable. Additionally, the relative positions of the steam guide structures described herein are noted to enhance the clarity of the disclosure. However, the positioning of the steam guide structures is not intended to be limiting on the various aspects of the invention. For example, first radially inner steam guide structure 18 is labeled as such to denote its radial position relative to the first radially outer steam guide structure 42. It is understood that first radially inner steam guide structure 18 may be one of a plurality of steam guide structures positioned radially inward of a second set of steam guide structures, wherein the second set of steam guide structures are positioned radially outward of the plurality of steam guide structures positioned radially inward. It is also understood that the terms “radial” or “radially,” used herein, are intended to denote a position relative to a central axis or point of rotation of turbine systems (e.g., first turbine system 30, etc.).

With reference to FIGS. 1, 3 and 4, a method of installing an example embodiment of exhaust hood 2 to first turbine system 30 is provided. In the embodiment, first radially inner steam guide structure 18 and first radially outer steam guide structure 42 may be pre-fabricated based on the size of the first set of LSB 34 that may be used with turbine system 30. First radially inner steam guide structure 18 and first radially outer steam guide structure 42 may be fabricated by any now known or later developed means of fabrication, e.g., die casting, injection molding, milling, boring, turning, etc. After fabrication of first radially inner steam guide structure 18, and first radially outer steam guide structure 42, first radially inner steam guide structure 18 may be releasably coupled to housing 4. More specifically, lower half 26 of first radially inner steam guide structure 18 may be releasably coupled to lower portion 10 of end wall 6 via releasable coupling 14. Next in the example embodiment, at least a portion of first rotor 32, which may include first set of LSB 34, may then be substantially disposed within exhaust hood 2. Additionally, first rotor 32 may be substantially concentric with lower half 26 of first radially inner steam guide structure 18. Following the positioning of at least a portion of first rotor 32 within exhaust hood 2, upper portion 8 may be coupled to lower portion 10 of housing 4 via the horizontal coupling joint (not shown). Next, upper half 24 of first radially inner steam guide structure 18 may be releasably coupled to lower half 26 via horizontal coupling joint 28. After upper half 24 and lower half 26 of first radially inner steam guide structure 18 are releasably coupled, first radially outer steam guide structure 42 may be releasably coupled to inner casing assembly 44 of first turbine system 30. Finally, exhaust hood 2 may be positioned such that first turbine system 30 may be positioned within housing 4 of exhaust hood 2. After first turbine system 30 is positioned within exhaust hood 2, first turbine system 30 is ready to begin operation to generate power, and in combination with first radially inner steam guide structure 18 and first radially outer steam guide structure 42, exhaust hood 2 may move steam used to generate power in first turbine system 30.

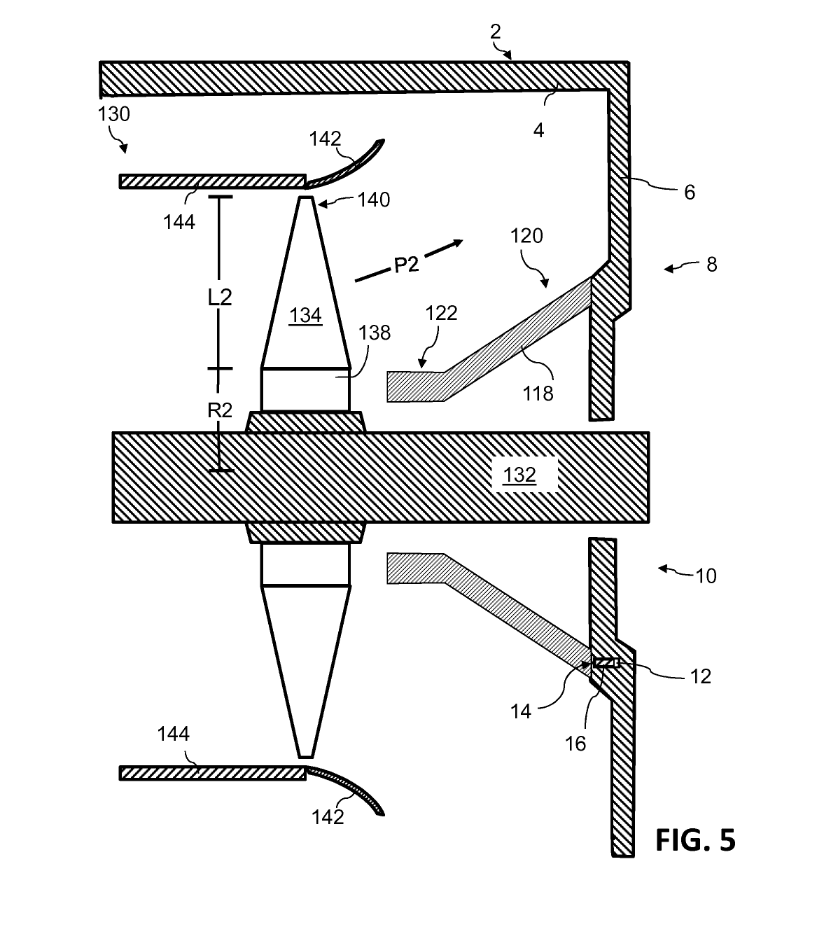

Turning to FIG. 5, a vertical cross-sectional side view of exhaust hood 2, including a second radially inner steam guide structure 118 and a portion of a second turbine system 130 according to embodiments of the invention is provided. In the Figures, it is understood that similarly numbered components (e.g., housing 4, end wall 6, upper portion 8, etc.) may function in a substantially similar fashion. Redundant explanation of these components has been omitted for clarity. Furthermore, in the embodiment, second turbine system 130 may be any conventional low-pressure steam turbine. As such, basic functionality of majority of the components may be omitted for clarity. As referenced with respect to FIG. 5, a second rotor 132 of second turbine system 130 may be configured to be releasably coupled to a plurality of distinct last stage buckets. As best shown in FIG. 5, first rotor 32 having first set of LSB 34 (FIG. 4) may be replaced with distinct second rotor 132 having a distinct second set of LSB 134. More specifically, first turbine system 30 may be uninstalled from exhaust hood 2, and replaced by second turbine system 130 having second set of LSB 134. By replacing first turbine system 30 having first set of LSB 34 with second turbine system 130 having second set of LSB 134, second turbine system 130 may operate with different efficiencies and may provide distinct power-output during operation. As shown in FIG. 5, second set of LSB 134 may be releasably coupled to second rotor 132 via a base 138 of second set of LSB 134. In the example embodiment of FIG. 5, second set of LSB 134 may have a second length (L2), which may be distinct from a first length (L1) of first set of LSB 34. The second length (L2) of second set of LSB 134 may be measured from the top of base 138 of second set of LSB 134, to a tip 140 of second set of LSB 134. Furthermore, as shown in FIG. 5, second set of LSB 134 may have a second radial position (R2), which may be distinct from first radial position (R1) of first set of LSB 34. Second radial position (R2) may include the radial distance of second rotor 132 and the height of base 138 of second set of LSB 134.

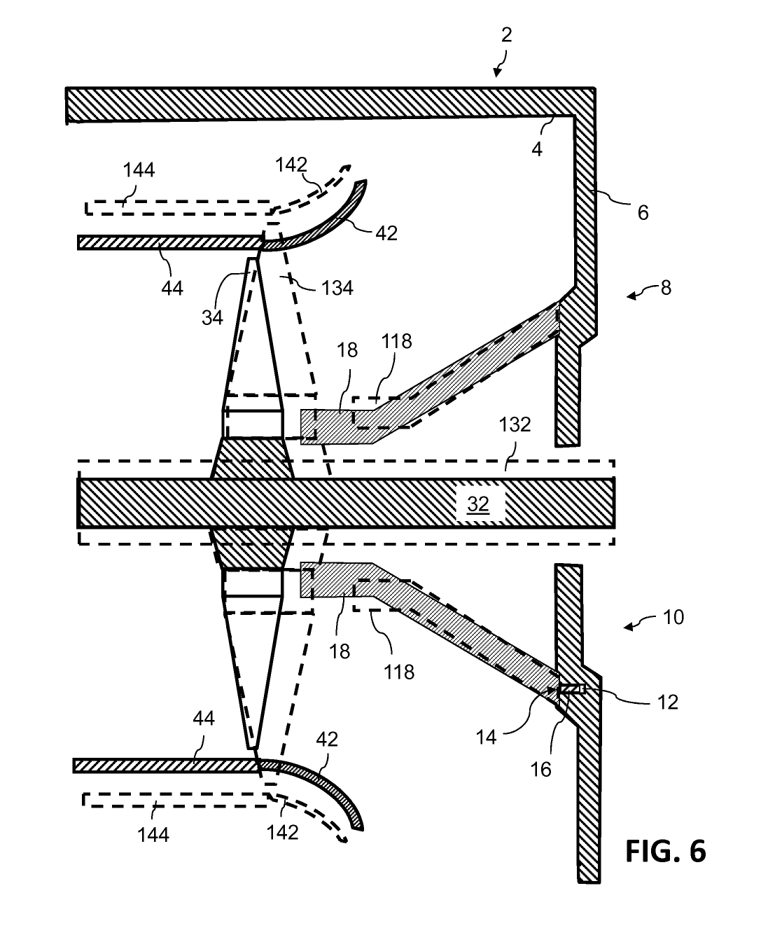

Briefly turning to FIG. 6, in an embodiment, second set of LSB 134 may be larger in length (e.g., L2>L1) than first set of LSB 34. In another embodiment, first set of LSB 34 may be larger in length (e.g., L1>L2) than second set of LSB 134. In a further embodiment, first length (L1) of first set of LSB 34, and second length (L2) of second set of LSB 134 may be substantially identical (e.g., L1=L2), and a configuration of first set of LSB 34, and second set of LSB 134 may be distinct. More specifically, the configuration of first set of LSB 34, and second set of LSB 134 may be distinct, in that the number of buckets are different, the width of the buckets are different, the pitch or angle of the buckets are different, the axial locations are different, the angles of the sidewalls are different, etc.

In reference to FIG. 5, the embodiment may also include a second radially inner steam guide structure 118, distinct from first radially inner steam guide structure 18 (FIG. 4), disposed within housing 4. Second radially inner steam guide structure 118 may be configured to replace first radially inner steam guide structure 18 within housing 4 in response to replacing first turbine system 30 having first set of LSB 34 with second turbine system 130 having second set of LSB 134. More specifically, in response to implemented second turbine system 130 having second set of LSB 134, second radially inner steam guide structure 118 may be releasably coupled, via releasably coupling 14, within exhaust hood 2. That is, exhaust hood 2 may be configured to be coupled to both first turbine system 30 and/or second turbine system 130 in order to provide distinct steam guide structures associated with each turbine system. More specifically, exhaust hood 2 may be manufactured with specific dimensions which may allow exhaust hood 2 to be coupled to a plurality of turbine system (e.g., first turbine system 30, second turbine system 130, etc.), independent of the dimensions of the LSB associated with each turbine system. In the embodiment, as shown in FIG. 5, first end 120 of second radially inner steam guide structure 118 may include second portion 16 of releasable coupling 14. Specifically, second portion 16 of releasable coupling 14 may be a substantially identical to second portion 16 that may be included in first end 20 of first radially inner steam guide structure 18. As a result of first end 120 having a substantially identical second portion 16, first portion 12 of releasable coupling 14 integral with lower portion 10 of end wall 6 may be configured to releasable couple second radially inner steam guide structure 118 to end wall 6 in a substantially similar way as discussed above with reference to FIG. 4.

With reference to FIGS. 5 and 6, second radially inner steam guide structure 118 may include first end 120 and a second end 122. In the embodiment, as shown in FIGS. 5 and 6, first end 120 may include a substantially frusto-conical shape, and may be positioned substantially adjacent end wall 6 of housing 4. Second end 122 may be integral with first end 120 and may include a substantially cylindrical shape. In an alternative embodiment, not shown, second radially inner steam guide structure 118 may include a single body having a substantially curved, frusto-conical shape. As shown in FIG. 5, second end 122 of second radially inner steam guide structure 118 may be positioned substantially adjacent base 138 of second set of LSB 138. In the embodiment, as shown in FIGS. 5 and 6, second radially inner steam guide structure 118 may include dimensions distinct from the dimensions of first radially inner steam guide structure 18. More specifically, as shown in FIG. 6, second radially inner steam guide structure 118 may include first portion 120 that may be shorter in length, and have a greater pitch or angular slope than first portion 20 of first radially inner steam guide structure 18. Additionally, second radially inner steam guide structure 118 may include second portion 122 that may be shorter in length than second portion 22 of first radially inner steam guide structure 18. The dimensional distinction(s) between first radially inner steam guide structure 18 and second radially inner steam guide structure 118 may depend, at least in part, on the dimension of the set of LSB (e.g., first set of LSB 38) that may be used in the turbine system (e.g., first turbine system 30), as discussed below.

Also shown in FIGS. 5 and 6, the embodiment may also include a plurality of second sets of middle stage buckets (not shown), and a second radially outer steam guide structure 142 coupled to a distinct inner casing assembly 144 of second turbine system 130. More specifically, second radially outer steam guide structure 142 may be releasably coupled to an end of inner casing assembly 144 of second turbine system 130, such that second radially outer steam guide structure 142 may be substantially disposed within housing 4 of exhaust hood 2, and positioned substantially adjacent a tip 140 of second set of LSB 134. Second radially outer steam guide structure 142 may be configured to replace first radially outer steam guide structure 42 in response to first turbine system 30 having first set of LSB 34 being replaced by second turbine system 130 having second set of LSB 134, and first radially inner steam guide structure 18 being replaced by second radially inner steam guide structure 118. With reference to FIGS. 5 and 6, inner casing assembly 144 may be positioned at a distance from second rotor 132, distinct from a distance of inner casing assembly 44 from first rotor 32, such that inner casing assembly 144 may provide sufficient space for second set of LSB 134 to operate within second turbine system 130.

In the embodiment, as shown in FIG. 5, second radially inner steam guide structure 118 and second radially outer steam guide structure 142 may correspond to second set of LSB 134. More specifically, exhaust hood 2 may have a custom built second steam guide structure 118 and a custom-built second radially outer steam guide structure 142 releasably coupled to housing 4, based upon the predetermined second length (L2) of second set of LSB 134 to be used in second turbine system 130. As shown in FIGS. 5 and 6, replacing first turbine system 30 having first set of LSB 34 with second turbine system 130 having second set of LSB 134 may provide a distinct steam path (P2) for steam moving within turbine system 130. Specifically in the embodiment shown in FIG. 6, the implementation of second set of LSB 134, which may have a larger second length (L2) then first length (L1) of first set of LSB 34, may provide a larger steam path (P2) for second turbine system 130. In order to provide optimum efficiency for the distinct steam path (P2) created by second set of LSB 134, exhaust hood 2 may include the custom built second radially inner steam guide structure 118 and a custom-built second radially outer steam guide structure 142. In replacing first set of LSB 34, first radially inner steam guide structure 18, and first radially outer steam guide structure 42 with second set of LSB 134, second radially inner steam guide structure 118 and second radially outer steam guide structure 142, respectively, distinct steam path (P2) may continue to be optimized within second turbine system 130.

Turning to FIG. 6, a vertical cross-sectional comparative view of exhaust hood 2, including the first radially inner steam guide structure 18 and associated portions of first turbine system 30 and the second radially inner steam guide structure 118 and associated portions of second turbine system 130, according to embodiments of the invention is provided. More specifically, FIG. 6 shows an upper portion of the embodiment depicted in FIG. 4, and the embodiment of FIG. 5, shown in phantom, for comparative purposes. As shown in FIG. 6, certain components of exhaust hood 2 (housing 4, end wall 6, etc.) may function similarly with the use first turbine system 30 having first set of LSB 34, first radially inner steam guide structure 18, and first radially outer steam guide structure 42, or second turbine system 130 having second set of LSB 134, second radially inner steam guide structure 118 and second radially outer steam guide structure 142. In an example embodiment, as shown in FIG. 6, housing 4, end wall 6, first portion 12 of releasable coupling 14, and second portion 16 of releasable coupling 14 may function similarly, regardless of the other components (e.g., first radially inner steam guide structure 18, second radially inner steam guide structure 118, etc.) that may be disposed within exhaust hood 2. In an example embodiment, exhaust hood 2 may be configured to provide support for a variety of radially inner steam guide structures, such that a single exhaust hood 2 may be coupled to a plurality of turbine systems (e.g., first turbine system 30, second turbine system 130, etc) having a variety of dimensionally distinct buckets. Additionally, exhaust hood 2 may be configured to provide support for a variety of radially inner steam guide structures, such that a single exhaust hood 2 may be used in a plurality of turbine systems which utilize a plurality of condensers (e.g., water-cooled condensers, air-cooled condensers, etc.).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine exhaust hood, comprising:
a housing having an end wall, the end wall including a first portion of a releasable coupling; and
a first radially inner steam guide structure disposed within the housing, the first radially inner steam guide structure including a second portion of the releasable coupling, integral with a first end of the first radially inner steam guide structure,
wherein the first portion and the second portion of the releasable coupling releasably couple the first radially inner steam guide structure to the end wall.

2. The exhaust hood of claim 1, wherein the first end includes a substantially frusto-conical shape, and a second end includes a substantially cylindrical shape.

3. The exhaust hood of claim 1, wherein the first portion and the second portion of the releasable coupling is positioned at a lower portion of the end wall.

4. The exhaust hood of claim 1, wherein the first radially inner steam guide structure further includes:
a lower half having the second portion of the releasable coupling; and an upper half of the first radially inner steam guide structure, wherein the lower half and the upper half of the first radially inner steam guide structure are configured to be releasably coupled.

5. The exhaust hood of claim 1, wherein the housing is configured to substantially receive a turbine system positioned substantially within the exhaust hood, the turbine system including:
a first rotor; and
a first set of last stage buckets coupled to the first rotor, the first set of the last stage buckets having a first length.

6. The exhaust hood of claim 5, wherein the first radially inner steam guide structure is substantially concentric with the first rotor.

7. The exhaust hood of claim 5, further comprising:
a first radially outer steam guide structure disposed within the housing and releasably coupled to an inner casing assembly of the turbine system.

8. The exhaust hood of claim 7, wherein a second end of the first radially inner steam guide structure is positioned substantially adjacent a base of the first set of the last stage buckets, and the first radially outer steam guide structure is positioned substantially adjacent a tip of the first set of the last stage buckets.

9. The exhaust hood of claim 5, further comprising:
a second rotor configured to replace the first rotor;
a second set of last stage buckets, distinct from the first set of last stage buckets, coupled to the second rotor, the second set of the last stage buckets having a second length, distinct from the first length of the first set of the last stage buckets; and
a second radially inner steam guide structure, distinct from the first radially inner steam guide structure, configured to replace the first radially inner steam guide structure within the housing.

10. The exhaust hood of claim 9, wherein the second radially inner steam guide structure includes a second portion of the releasable coupling, integral with a first end of the second radially inner steam guide structure, and the first portion and the second portion of the releasable coupling releasably couple the second radially inner steam guide structure to the end wall.

11. A steam guide structure, comprising:
a body having:
a first end including a first portion of a releasable coupling, the first end configured to be releasably coupled to a turbine exhaust hood via the first portion of the releasable coupling; and
a second end located substantially proximate the first end and positioned within the turbine exhaust hood.

12. The steam guide structure of claim 11, wherein the first end includes a substantially frusto-conical shape, and the second end includes a substantially cylindrical shape.

13. The steam guide structure of claim 11, wherein the first portion of the releasable coupling is positioned at a lower portion of the turbine exhaust hood.

14. The steam guide structure of claim 11, wherein the body further includes:
a lower half having the first portion of the releasable coupling; and
an upper half of the body, wherein the lower half and the upper half of the body are configured to be releasably coupled.

15. The steam guide structure of claim 11, wherein the turbine exhaust hood is configured to substantially receive a turbine system positioned substantially within the exhaust hood, the turbine system including:
a first rotor; and
a first set of last stage buckets coupled to the first rotor.

16. The steam guide structure of claim 15, wherein the second end is positioned substantially adjacent a base of the first set of the last stage buckets.

17. The steam guide structure of claim 15, wherein the first end is positioned substantially adjacent a top end of the first set of the last stage buckets.

18. A method, comprising:
providing a first steam guide structure;
releasably coupling the first steam guide structure to a turbine exhaust hood; and
installing the turbine exhaust hood onto a first turbine system, the first turbine system including a first set of last stage buckets having a first length.

19. The method of claim 18, further comprising:
replacing the first turbine system including the first set of last stage buckets with a second turbine system including a second set of last stage buckets, the second set of last stage buckets having a second length, distinct from the first length of the first set of last stage buckets; and
replacing the first steam guide structure with a second steam guide structure configured to be releasably coupled to the turbine exhaust hood, the second steam guide structure having a dimension distinct from a dimension of the first steam guide structure.
